(19) United States
(12) Patent Application Publication
(10) Pub. No.: US 2002/0069159 A1
(43) Pub. Date: Jun. 6, 2002

(54) Method and apparatus for recycling declined credit applications

(76) Inventors: Kevin L. Talbot, Richmond Hill (CA); Duncan A. Ross, Novato, CA (US); Stephanie A. Febonio, Hudson, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 09/730,483

(22) Filed: Dec. 5, 2000

(51) Int. Cl. G06F 17/60

(52) U.S. Cl. 705/38

(57) ABSTRACT

A method, apparatus and article of manufacture for recycling declined credit applications in an electronic credit request system provides for a first lender receiving a credit application from a borrower. A masked credit report and a credit score is generated for the borrower. The credit application is analyzed based upon the masked credit report and the credit score. If the credit application is declined then the credit application, the masked credit report and the credit score are transmitted to a credit request recycling processor. The credit request recycling processor finds a credit risk match from a multiplicity of other potential lenders.

### RELATED APPLICATIONS

This application is related to co-pending United States Patent Application titled “METHOD AND APPARATUS FOR PROVIDING A REVERSE BLIND ELECTRONIC CREDIT AUCTION” by Kevin L. Talbot, Duncan A. Ross and Arlene A. Greene (Attorney Docket Number 3059.1000-000), filed on even date, the entire teachings of which are incorporated herein by reference.

### BACKGROUND OF THE INVENTION

This invention relates generally to electronic credit applications and more specifically to subsequent processing of declined electronic credit applications.

Borrowers apply for credit for many reasons, using a variety of options. Traditionally, a borrower would go to the local branch of their bank and apply for a loan to cover an anticipated expense or large purchase. Customer loyalty to a single bank has diminished as more and more options are created for borrowers to get exposure to offers from multiple lenders. With the advent of online lending, a borrower can complete a single electronic credit application and instantly apply for credit from multiple lending institutions. Sources for electronic credit applications include telephone, Web pages for traditional banks, Web pages for virtual banks, standalone kiosk-style electronic information interfaces, and Web pages for sellers of products and services that may require financing in order to consummate a sale.

Traditional and virtual banks typically provide specific credit products, for example home mortgages, automobile loans, credit cards, equity loans and lines of credit. These products have criteria based upon the purpose of the loan as well as criteria based upon the creditworthiness of the borrower. When a borrower makes a credit request that does not match any of the products that the bank offers, or the borrower's credit is not at a level the bank deems appropriate, the credit application is declined.

Online commerce sites at times offer products and services that require a loan, or financing, in order to facilitate a purchase. This is especially true of sites that cater to small business purchasers. The ability to provide financing as part of an online commerce transaction enhances a business' chance of making a successful sale. Many online commerce businesses have arrangements with primary lenders to provide credit to purchasers of their products and services. These primary lenders have certain criteria relating to the credit worthiness of the purchaser. Certain potential purchasers will not meet the primary lender's criteria, therefore their application for credit will be declined and a sale is potentially lost.

### SUMMARY OF THE INVENTION

The present invention provides for subsequent processing of initially declined credit applications in electronic credit request systems. According to the present invention an initial lender receives and analyzes a credit application from a borrower. If the lender declines the credit application, the credit application is transmitted to a credit request recycling processor for further consideration. A credit request recycling processor may then transmit offers to the borrower based upon products provided by lenders associated with the recycling processor. These recycling lenders may provide products that meet the needs of the borrower, when the primary (initial) lender can not.

A method, apparatus and article of manufacture for recycling declined credit applications in an electronic credit request system is disclosed where a first lender receives a credit application from a borrower. The system generates a masked credit report and credit scores for the applying borrower. The lender analyzes the credit application based upon the masked credit report and the lender's preferred credit score. If the credit application is declined based upon the first lender's criteria for extending credit to the borrower the system transmits the credit application, the masked credit report and the credit score to a credit request recycling processor for subsequent processing.

Declining a credit application can be done based upon a first lender's criteria, including an evaluation of the credit worthiness of the borrower.

Certain primary lenders have a desire to exclude certain other lenders from subsequent processing of their declined credit applications. For those lenders an identifier can be sent to the credit request recycling processor, such that a predefined second tier lender is excluded from receiving the declined credit application.

Credit application declinations are a lost opportunity for primary lenders and a potential customer relations problem. Recycling these declined credit applications enhances customer relationship management by satisfying a customer need when the primary lender does not have a compatible product available. Recycling allows the primary lender to maintain an ongoing relationship with the declined customer. Additionally, the primary lender has the opportunity to earn a commission on any possible downstream sales of credit products. The commission can be used to cover the expense of initially processing the subsequently declined credit application.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a computer system on which an embodiment of the present invention is implemented.

FIG. 2 illustrates the internal structure of a computer of FIG. 1.

FIG. 3 illustrates the flow of information in the credit request recycling process according to an embodiment of the present invention.

FIG. 4 is a diagram of components in an embodiment of the present invention along with various input and output interactions.

FIG. 5 is a flowchart of the credit request recycling process according to an embodiment of the present invention.

### DETAILED DESCRIPTION OF THE INVENTION

A description of preferred embodiments of the invention follows.

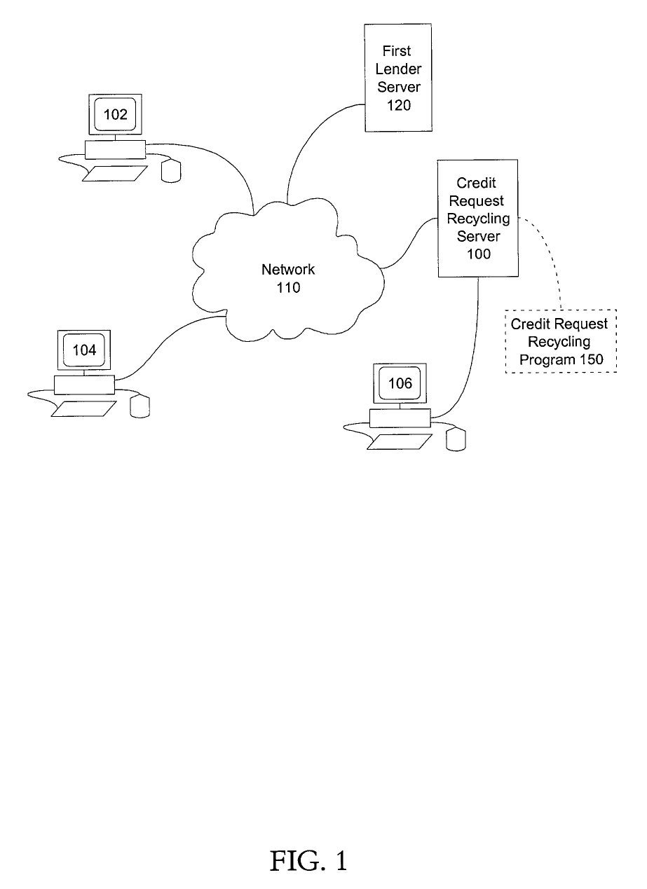

FIG. 1 illustrates a computer system on which an embodiment of the present invention is implemented. Client computers (102, 104, 106) provide processing and input/output devices in a system for recycling declined credit applications. Server computers (100, 120) are also linked to a network 110 and contain software for recycling declined credit applications. Network 110 can be part of the Internet, the worldwide collection of computers, networks and gateways that use the TCP/IP suite of protocols to communicate with one another. The Internet provides a backbone of high-speed data communication lines between major nodes and host computers, consisting of thousands of commercial, government, educational, and other computer systems, that route data and messages.

In one embodiment of the present invention, a First Lender process executes on First Lender server 120 and a Credit Request Recycling process executes on Credit Request Recycling server 100. Alternatively, the First Lender process and the Credit Request Recycling process can execute on the same server.

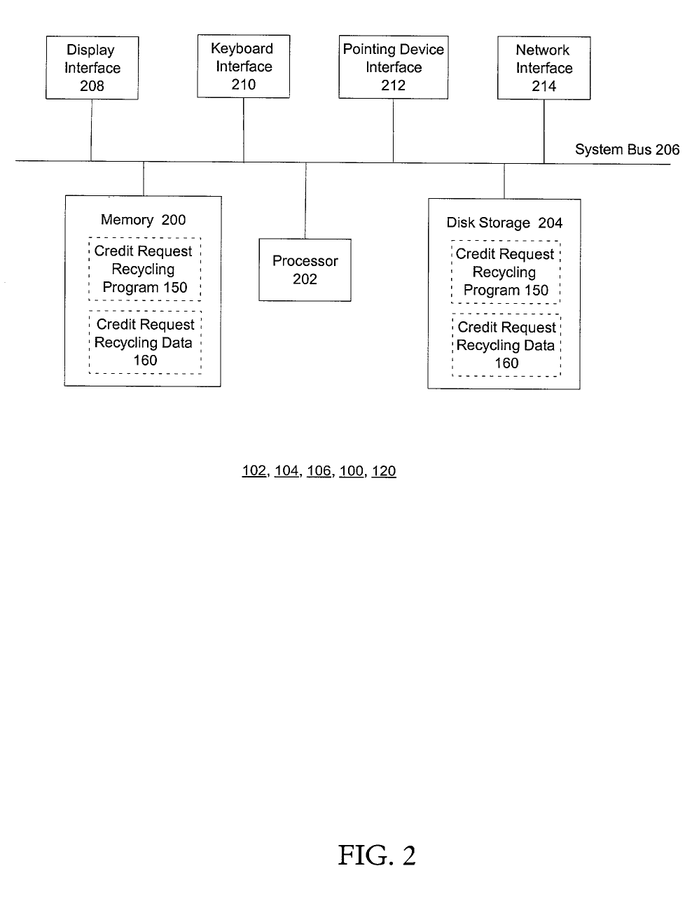

FIG. 2 illustrates the internal structure of a computer of FIG. 1. FIG. 2 illustrates client computer (102, 104, 106) and the server computers (100,120). The client computers (102, 104, 106) and server computers (100,120) contain a system bus 206; a bus is a set of hardware lines used for data transfer among the components of a computer system. A bus is essentially a shared channel that connects different parts of the system (e.g., processor, disk-drive controller, memory, and input/output ports) and enables the different parts to transfer information. Attached to system bus 206 is display interface 208, which allows display devices to communicate with other components on system bus 206. Keyboard interface 210 and pointing device interface 212 are also attached to system bus 206 and allow various input devices to communicate with other components on system bus 206. Network interface 214 provides a link to an external network (e.g., network 110) allowing processes running on a client computer (102, 104, 106) to communicate with a server computer (100,120) connected to network 110. A memory 200 stores computer software instructions and data structures used to implement an embodiment of the present invention (e.g., Credit Request Recycling Program 150). A disk storage device 204 is provided for non-volatile storage on computers (102, 104, 106, 100, 120) to store, for example Credit Request Recycling Program 150 and Credit Request Recycling Data 160. A processor 202 executes instructions and accesses data stored in memory 200, allowing the networked computers (102, 104, 106, 100, 120) to process and recycle declined credit applications according to an embodiment of the present invention.

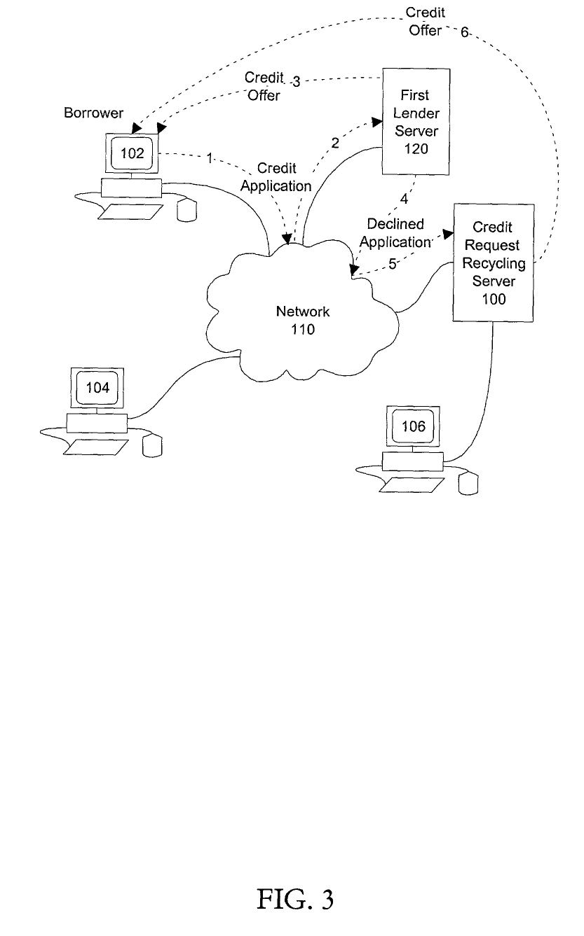

FIG. 3 illustrates the flow of information in the credit request recycling process according to an embodiment of the present invention. A borrower using client computer 102 completes an electronic credit application and submits it to a First Lender server 120 using network 110. The electronic credit application may be presented to the borrower using an HTML/XML based Web page hosted by a Web server associated with First Lender server 120. The borrower will typically be asked to fill in a series of fields of a credit application presented in forms on the Web page. These forms may be implemented in HTML, XML or other similar content authoring languages. Information concerning the borrower's personal, employment, financial and credit history can be gathered. Certain fields of the credit application form are required to have entries in order for the credit application to be considered complete. Once complete the credit application can be sent (1,2) to the First Lender server 120 for processing. The first lender can make an agreement with the borrower based upon the electronic credit application and thus originate a credit transaction (e.g., a loan) with the borrower (3). For simplicity credit offer (3) is shown going directly from First Lender server 120 to the client computer 102 that the borrower is using. Typically, First Lender server 120 would utilize network 110 to transport the credit offer. If the first lender declines to make an agreement with the borrower the electronic credit application can be sent (4,5) to Credit Request Recycling server 100 via network 110. Credit Request Recycling server 100 provides access to a pool of financial institutions that may be willing to provide credit to the borrower based upon the electronic credit application.

One system for recycling declined credit applications includes online merchandise vendors, for example a computer equipment vendor such as Hewlett-Packard. Computer equipment vendors can secure a line of credit with a creditor (e.g., GE Financial) for use in purchasing the vendor's computer equipment. The creditor often has criteria, based upon the potential purchaser's credit worthiness and the creditor's available funds, which are used to determine whether the specific purchase meets the creditor's requirements. First Lender server 120 can evaluate a potential purchaser's credit worthiness using a variety of credit reporting services (e.g., TransUnion and Dun & Bradstreet) and credit scoring services (e.g., Fair, Isaac & Company). Credit requests that meet the creditor's criteria can result in an agreement between the purchaser/borrower and the creditor, thus enabling the purchase of the computer equipment desired.

Credit requests that are declined need not terminate a potential sale. Declined credit applications, along with retrieved credit reports and scores, are sent to Credit Request Recycling server 100 for subsequent processing. The present invention uses a masking technique when sending the credit reports and credit scores such that the credit applicant's name and address (except state) and the like are not sent to Credit Request Recycling server 100.

Credit Request Recycling server 100 has access to a network of lenders that may find the credit application acceptable based upon their own criteria for offering credit. A lender within the network of lenders associated with the Credit Request Recycling server 100 may accept a credit request that was declined by the first lender based upon the second lender having a higher tolerance for risk and/or more funds available at the time of the credit request. If Credit Request Recycling server 100 finds a lender whose criteria matches the credit application, a credit offer (6) may be made to the purchaser/borrower. For simplicity, credit offer (6) is shown (in FIG. 3) going directly from Credit Request Recycling server 100 to the client computer 102 that the borrower is using. Typically Credit Request Recycling server 100 would utilize network 110 to transport the credit offer. With a credit offer in hand the purchaser can now make the desired purchase.

In effect, the first lender offers such recycling of initially declined credit applications as a referral, or alternate means to obtain financing, for the borrower. As such the initial declination, turned referral, appears to the borrower as a positive experience. This experience may enhance the relationship between the first lender and the borrower in an otherwise potentially negative relationship situation.

Another example of a system for recycling declined credit applications involves financial institutions. Like the creditors in the online merchandise vendors example, financial institutions have criteria for offering credit. Financial institutions can include banks, lessors, mortgage lenders, insurance companies and others who may act as lenders. The products these financial institutions offer can include loans, leases, credit cards and lines of credit. Certain credit applications that the financial institutions receive do not meet their criteria for lending, but for customer relationship reasons the financial institution may not want to simply decline the credit application. In these cases, the financial institutions transmit the initially declined credit applications, along with any masked credit reports, credit scoring and analysis they have done, to Credit Request Recycling server 100 for subsequent processing.

In certain circumstances, when a financial institution initially declines a credit application the financial institution may not want the declined credit application to be recycled (i.e., subsequently processed) by particular subsequent lenders. For example, in a very competitive market between Bank A and Bank B, Bank A may not want its declined credit application being subsequently processed by Bank B. An embodiment of the present invention excludes predefined lenders from subsequent processing of declined credit applications by transmitting an identifier of the first lender to the Credit Request Recycling server 100.

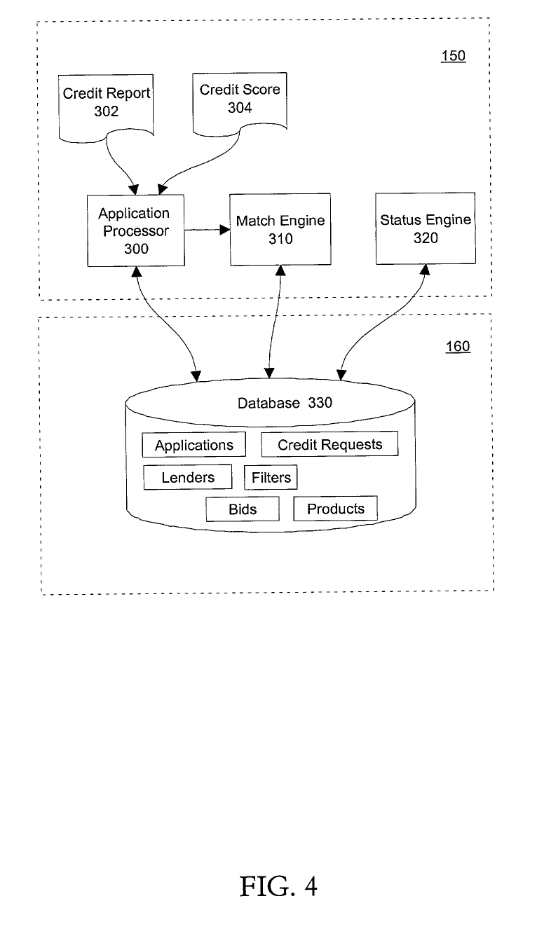

FIG. 4 is a diagram of components in an embodiment of the present invention along with various input and output interactions. A Credit Request Recycling Program 150 can be implemented using First Lender server 120 and Credit Request Recycling server 100. First Lender server 120 and Credit Request Recycling server 100 may be a single physical computer, or multiple physical computers. Credit Request Recycling Program 150 interacts with Credit Request Recycling Data 160 to provide recycling of initially declined credit applications.

A database 330 stores data objects used to provide recycling of declined credit applications. Electronic credit applications can be stored at various points during the application process, both as application checkpoints and completed credit applications. Information about the lenders within the network and their products is also stored along with filters built to implement the various criteria the lenders define for their specific product offers. Processed credit applications become credit requests upon which lenders within the network can bid. The credit requests and bids are stored in database 330.

Credit Request Recycling Program 150 provides various processing capabilities that assist in the recycling of initially declined credit applications. An online credit application is initially processed by application processor 300. Application processor 300 checks for consistent and/or fraudulent data within the electronic credit application. Inconsistency checks include zip codes that don't match a city or town specified, zip codes that do not match a telephone area code specified and various other out-of-bounds entries. Additionally, fraud can be detected by comparing an electronic credit application to a set of known, historically fraudulent applications.

A credit report 302 is obtained from one, or more, of many credit reporting services (e.g., Experian, TransUnion, Dun & Bradstreet). Various parts of the credit report (e.g., name and address, except state) can be masked, such that a bidding lender will not see them. Some, or all, of the masked information can be revealed to a winning bidder (lender) if an applicant chooses the lender's bid. Additionally, a credit score 304 is generated using information in the electronic credit application and information in the credit report 302. In one preferred embodiment, the credit scoring is provided by the Small Business Scoring Service^{SM} of Fair, Isaac & Company, an information services company headquartered in San Rafael, Calif. USA.

The credit application, along with associated credit reporting and/or credit scoring information is processed by a match engine 310. Match engine 310 matches the credit application to a lender's products based upon predefined criteria specified by the lender and stored in a Filters table in database 330. Preferably match engine 310 executes appropriate ones of those filters. If no matches are found or, if no subsequent offers are made the credit application can be transmitted to a subsequent network of lenders for possible fulfilment of the pending credit request.

Status engine 320 keeps track of, and reports on declined credit applications for the Credit Request Recycling process.

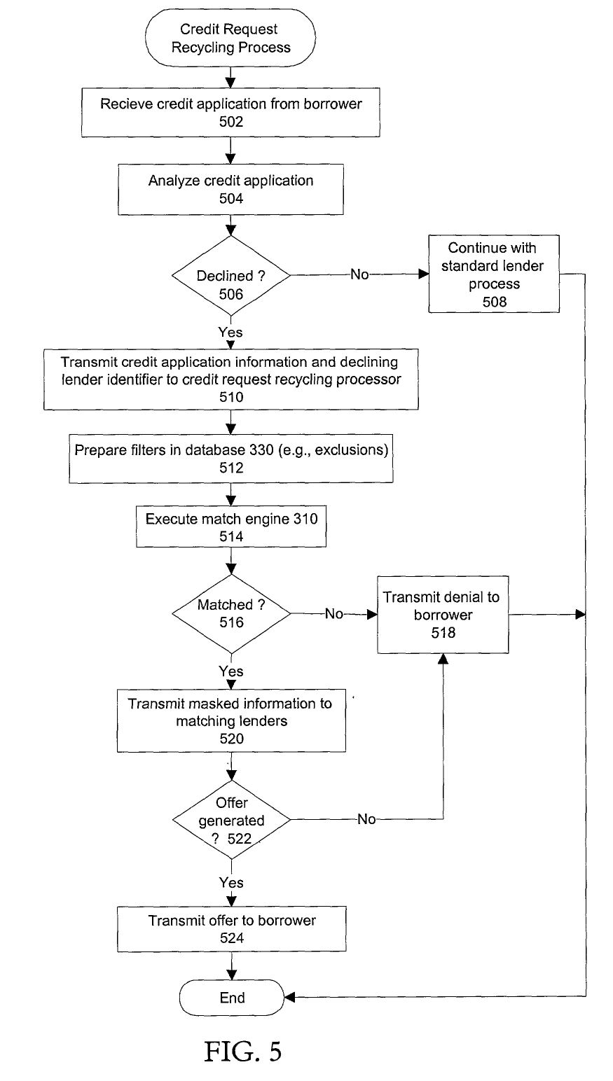

FIG. 5 is a flowchart of the credit request recycling process according to an embodiment of the present invention. The credit request recycling process begins at Step 502 by receiving a credit application from a prospective borrower. The application can be received as the result of an applicant filling out an electronic form on a Web site or from any number of other electronic or paper-based sources. The credit application is analyzed (Step 504) for consistency, fraud and conformance to lender criteria. The lender makes a decision (Step 506) as to whether the credit application is declined. If the credit application is accepted by the lender, the standard lender process continues at Step 508. Otherwise, if the credit application is declined, the credit application may be recycled by transmitting the credit request and a lender identifier to a credit request recycling processor at Step 508. The credit request recycling processor (as described in FIG. 4) can then process the credit request. At Step 512 the filters maintained by Credit Request Recycle processor are prepared.

Lender exclusion filters allow an initial lender to exclude certain other lenders from subsequently processing the credit request. Exclusion may be desirable when specific financial institutions are in a directly competitive situation. Other reasons for exclusion may include governmental restrictions placed on relationships between various types of financial institutions. In another preferred embodiment, the filters stored in database 330 for each initial lender are pre-loaded with specific excluded subsequent lenders. Once the processing of the credit request determines that at least one financial institution remains after the exclusion filtering, then the match engine executes (Step 514) and applies specific lender criteria to the credit request in order to determine if a match is found (Step 516). If no lender's criteria matches the credit request then a denial is transmitted to the borrower (Step 518). The denial can be sent directly to the borrower, or the denial can be routed through the initial lender. If the credit request matches a lender's criteria then the masked credit report information is sent to the matching lenders (Step 520). Lender decide whether or not to generate an offer (Step 522), if it is decided that no offer is to be made then processing continues with a denial being transmitted to the borrower (Step 518). Otherwise, the lender can transmit an offer to the borrower (Step 524). Again, depending upon the relationship between the initial lender and the Credit Request Recycling process, the offer can be sent directly to the borrower, or the denial can be routed through the initial lender.

In one example a borrower may request a loan from Bank A. Based upon the borrowers creditworthiness and/or other lender criteria, Bank A may decline the borrower's credit request. In an embodiment of the present invention the borrower's declined credit application can be submitted to a pool of other lenders (e.g., Bank B, Bank C and Bank D) for processing. This allows Bank A to decline the borrower's credit request while still maintaining a relationship with the borrower as subsequent lenders assess the credit request.

While this invention has been particularly shown and described with references to preferred embodiments thereof, it will be understood by those skilled in the art that various changes in form and details may be made therein without departing from the scope of the invention encompassed by the appended claims.

For example a lender is not necessarily a traditional bank; other financial institutions including mortgage lenders, equipment leasing companies, insurance companies and private equity providers may act as lenders. A person of ordinary skill in the art will recognize that these, as well as other financial institutions, may act as lenders within the scope of the present invention.

Further, processing by First Lender server 120 and Credit Request Recycling server 100 may be in accordance with related co-pending United States Patent Application titled “A METHOD AND APPARATUS FOR PROVIDING A REVERSE BLIND ELECTRONIC CREDIT AUCTION”, filed by the assignee of this application. In that case, advantages of masked and soft-pulled credit reports being used in a reverse blind credit auction are incorporated into the present invention.

What is claimed is:

1. A method of recycling declined credit applications in an electronic credit request system comprising the steps of:
receiving, by a first lender, a credit application from a borrower;
generating a masked credit report and a credit score for the borrower;
analyzing the credit application based upon the masked credit report and the credit score;
declining the credit application based upon the first lender's criteria for extending credit to the borrower; and
transmitting the credit application, the masked credit report and the credit score to a credit request recycling processor.

2. The method of claim 1 wherein the first lender's criteria includes an evaluation of the credit worthiness of the borrower.

3. The method of claim 1 wherein the step of transmitting further comprises:
transmitting an identifier of the first lender to the credit request recycling processor such that a predefined second lender is excluded from processing the declined credit application.

4. The method of claim 1 wherein each of the receiving, generating, analyzing, declining and transmitting steps are executed automatically using computer programmed instructions.

5. An apparatus for recycling declined credit applications comprising
a first receiver receiving a credit application from a borrower;
a masked credit report and a credit score generated for the borrower;
an analyzer analyzing the credit application based upon the masked credit report and the credit score;
a decision unit declining the credit application based upon the first lender's criteria for extending credit to the borrower; and
a transmitter transmitting the credit application, the masked credit report and the credit score to a credit request recycling processor.

6. The apparatus of claim 5 wherein the first receiver comprises criteria including an evaluation of the credit worthiness of the borrower.

7. The apparatus of claim 5 wherein the first receiver comprises criteria including an evaluation of the funds available from lender.

8. The apparatus of claim 5 wherein the apparatus is a computer automatically executing computer programmed instructions within the receiver, the analyzer, the decision unit and the transmitter.

9. An apparatus for recycling declined credit applications in an electronic credit request system comprising:
a means for receiving, by a first lender, a credit application from a borrower;
a means for generating a masked credit report and a credit score for the borrower;
a means for analyzing the credit application based upon the masked credit report and the credit score;
a means for declining the credit application based upon the first lender's criteria for extending credit to the borrower; and
a means for transmitting the credit application, the masked credit report and the credit score to a credit request recycling processor.

10. A computer program product comprising:
a computer usable medium for recycling declined credit applications in an electronic credit request system; and
a set of computer program instructions embodied on the computer usable medium, including instructions to:
receive, by a first lender, a credit application from a borrower;
generate a masked credit report and a credit score for the borrower;
analyze the credit application based upon the masked credit report and the credit score;
decline the credit application based upon the first lender's criteria for extending credit to the borrower; and
transmit the credit application, the masked credit report and the credit score to a credit request recycling processor.

11. A computer data signal embodied in a carrier wave comprising a code segment for providing a reverse blind credit auction between a borrower and a group of lenders; and
a set of computer program instructions embodied in the code segment, including instructions to:
receive, by a first lender, a credit application from a borrower;
generate a masked credit report and a credit score for the borrower;
analyze the credit application based upon the masked credit report and the credit score;
decline the credit application based upon the first lender's criteria for extending credit to the borrower; and
transmit the credit application, the masked credit report and the credit score to a credit request recycling processor.
